(19) United States
(12) Patent Application Publication
(10) Pub. No.: US 2013/0036889 A1
(43) Pub. Date: Feb. 14, 2013

(54) ROTARY CUTTING DEVICE

(71) Applicant: Wilhelm Aichele, Crailsheim (DE)

(72) Inventor: Wilhelm Aichele, Crailsheim (DE)

(21) Appl. No.: 13/621,886

(22) Filed: Sep. 18, 2012

Related U.S. Application Data
(63) Continuation of application No. 12/077,532, filed on Mar. 18, 2008, now abandoned.

(30) Foreign Application Priority Data
Mar. 30, 2007 (DE) 10 2007 016 451

(51) Int. Cl. B26D 1/22

(52) U.S. Cl. 83/343

(57) ABSTRACT

A rotary cutting is provided which includes a machine frame, a cutting roll rotatably mounted on the machine frame, and a counter roll mounted on the machine frame. The cutting roll and/or the counter roll are formed from an inner core and an outer sleeve disposed around the inner core. The outer sleeve is spaced apart from the inner core. At least one counter bearing is disposed on the inner core, on which the outer sleeve is supported.

The present application is a continuation of commonly-owned co-pending U.S. patent application Ser. No. 12/077,532 filed on Mar. 18, 2008, which claims priority of German application number 10 2007 016 451.5 filed on Mar. 30, 2007, each of which is incorporated herein and made a part hereof by reference.

### BACKGROUND OF THE INVENTION

The invention relates to a rotary cutting device, comprising a machine frame, a cutting roll rotatably mounted on the machine frame, and a counter roll mounted on the machine frame, wherein the cutting roll and/or the counter roll comprise an inner core and an outer sleeve disposed around the inner core.

From DE 39 24 053 A1 a device for effecting the rotary cutting of material webs is known, comprising a machine frame and comprising rolls, which are supported in pivot bearings on the machine frame and rotationally driven and define a cutting area, namely a cutting roll and a mating cutting roll, which form between them in the cutting area a roll gap for passage of the material web. The cutting roll and mating cutting roll by means of distance rings disposed on them outside of the cutting area are supported so as to roll directly on one another. Between the distance rings at least one adjustable pressure roller member acts on at least one of these rolls and presses this one roll with an adjustable force against the other roll.

From EP 1 238 765 A2 a cutting device is known, in which the cutting tool is biased substantially parallel to an axis of rotation. The cutting tool comprises an outer sleeve, on which a cutting edge is seated, and an inner part, wherein the outer sleeve and the inner part are braced towards one another with a clamping force effect substantially parallel to an axis of rotation of the cutting tool.

Further rotary cutting devices are known from EP 0 976 510 A2, EP 1 180 419 A1, EP 1 186 387 A2 and EP 1 721 712 A1.

### SUMMARY OF THE INVENTION

In accordance with the present invention, a rotary cutting device is provided, which is of a simple construction and provides a high cutting quantity.

In accordance with an embodiment of the invention, the outer sleeve is spaced apart from the inner core and on the inner core there is disposed at least one counter bearing, on which the outer sleeve is supported.

In the solution according to the invention the outer sleeve is non-rotatably supported not by means of its entire inner surface against the inner core but only by means of at least one “discrete” counter bearing. The at least one counter bearing may in this case be disposed both on the cutting roll and on the counter bearing or only on the counter roll or only on the cutting roll.

By means of the at least one counter bearing it is possible to set a defined flow of force at the cutting roll and/or counter roll, by means of which the effect is achievable that under the action of cutting forces the outer sleeve or outer sleeves bow to a lesser extent than the inner core or inner cores. During cutting the fundamental problem arises that the cutting roll and the counter roll bend, because they are clamped in place at least at one end on the machine frame. Under the action of cutting forces, the counter roll bends in a direction away from the cutting roll and the cutting roll bends in a direction away from the counter roll. The result is an enlarged gap between the surfaces of the cutting roll and the counter roll that may lead to an impairment of the cutting quality.

With the solution according to the invention it is possible to reduce the bending of the cutting roll and/or counter roll at the surface since by means of the counter bearing forces may be guided away from the outer sleeve into the inner core and from there via a bearing arrangement. Given a corresponding arrangement of the at least one counter bearing, it is therefore possible to reduce the relative bowing at the surface of the cutting roll and/or counter roll. The arrangement and configuration of the at least one counter bearing depends on the respective application.

The solution according to the invention makes it possible also to use “less stiff” cutting rolls and/or counter rolls, i.e. in particular to use rolls that have a relatively small diameter and are relatively long. This in turn makes it possible for example to produce large-area cuts that are impossible using rotary cutting devices with shorter rolls. It is further possible in this way also to achieve a higher cutting rate if longer rolls are provided, on which a plurality of cutting areas are disposed.

In particular, the at least one counter bearing is disposed and configured in such a way that forces, which the cutting roll and counter roll exert on one another, may be removed in a defined manner by means of the at least one counter bearing on the counter roll and/or cutting roll. A flow of force at the counter roll and/or cutting roll is achievable, whereby the bowing of the outer sleeve is smaller than the bowing of the inner core.

For the same reason, it is advantageous if the at least one counter bearing is disposed and configured in such a way that the outer sleeve is movable by elastic deformation relative to the inner core. A relative mobility between outer sleeve and inner core enables a relative excursion between outer sleeve and inner core. The effect may therefore be achieved that the outer sleeve bends to a lesser extent than the inner sleeve under the action of cutting forces.

For the same reason, it is advantageous if the at least one counter bearing is disposed and configured in such a way that during a cutting operation a bowing of the outer sleeve is smaller than a bowing of the inner core.

It is advantageous if outside of the at least one counter bearing between the outer sleeve and the inner core there is an intermediate space (clearance zone). The height of this clearance zone (in radial direction) may be in an order of magnitude range of between for example 2 μm and 100 μm. It may also be greater. This clearance zone allows a relative excursion between the outer sleeve and the inner core in order thereby in turn to keep low the bowing at the surface of the cutting roll and/or counter roll.

For the same reason, it is advantageous if between adjacent counter bearings there is an intermediate space (clearance zone). The outer sleeve is then mounted on the inner core by means of discrete counter bearings.

It is advantageous if the at least one counter bearing is disposed and configured in such a way that there arises at the cutting roll and/or counter roll during a cutting operation an at least approximately symmetrical flow of force in relation to the cutting roll length and/or counter roll length. The flow of force is in particular symmetrical in relation to a transverse centre plane (which is perpendicular to the axis of rotation) of the cutting roll and/or counter roll. It is therefore possible to achieve at the surface of the cutting roll a minimized bowing that is symmetrical to the said centre plane.

It is in principle possible for the at least one counter bearing to be formed for example by a plurality of balls that are disposed on the inner core. In an—in manufacturing terms—simple form of construction, the at least one counter bearing comprises an annular region that is disposed on the inner core. The annular region surrounds the inner core in particular in a band-like manner. The annular region is formed for example by a ring element that is disposed on the inner core. The annular region may alternatively be formed integrally on the inner core.

The width of an annular region is smaller than the total length of the respective counter roll and/or cutting roll and is in particular considerably smaller. It is for example at most 30% of the respective total length. In principle, it is advantageous if the annular region has as low a width as possible. At the annular region, where forces are transmitted, the pressure per surface unit does however have to be within the elastic range. This defines the minimum extent of the annular region.

In one form of construction it is provided that the outer sleeve is fixed on the at least one counter bearing for example by means of positive-locking elements. In this way, the outer sleeve is easily fixable axially and radially relative to the inner core.

It may be provided that at least one seal is disposed between the outer sleeve and the inner core. The seal is disposed in particular on one or more end faces of the outer sleeve. In this way, it is possible to seal off an intermediate space between the outer sleeve and the inner core.

It is quite particularly advantageous if the at least one counter bearing is disposed symmetrically on the cutting roll and/or counter roll. If for example a single counter bearing is provided for the cutting roll or counter roll, then it is disposed centrally (in relation to a counter roll length and/or cutting roll length). If a plurality of counter bearings are provided, then they are disposed in particular symmetrically relative to a centre plane of the counter roll and/or cutting roll.

It may be provided that, if the cutting roll comprises an outer sleeve, one or more cutting edges are disposed on the outer sleeve of the cutting roll.

If the cutting roll and the counter roll are provided with in each case at least one counter bearing, an opposite-lying arrangement of counter bearings is particularly advantageous. A counter bearing of the cutting roll and a counter bearing of the counter roll are then positioned opposite one another. In this case, the counter bearings are arranged to be aligned in a direction transversely of an axis of rotation of the cutting roll. In this way, forces may be removed in a defined manner and the surface bowing both at the cutting roll and at the counter roll may be minimized. As a result, an optimum cutting result is obtained.

In one form of construction the cutting roll is supported against the counter roll by means of at least one supporting ring. The at least one supporting ring may in this case be disposed on the cutting roll or the counter roll.

In particular, a first supporting ring and a second supporting ring are then provided, wherein the at least one counter bearing is disposed on the counter roll and/or cutting roll between the first supporting ring and the second supporting ring. In this way, an optimization of the flow of force is achievable.

The counter roll is in particular rotatably mounted. It may in this case be driven directly (by its own drive or via a gear device that is connected to the drive of the cutting roll). In principle it is also possible for the counter roll to be driven by friction locking with material that is to pass through.

In one form of construction, the cutting roll is mounted at two ends on the machine frame. Then in particular a first pivot bearing and a spaced-apart second pivot bearing are provided.

In this case, it is advantageous if the counter roll is also mounted at two ends on the machine frame.

It is also possible for the cutting roll to be mounted at one end (for example rotatably by means of a single bearing) on the machine frame. Such a rotary cutting device with a cantilevered cutting roll may be constructed in a compact manner.

In this case, the counter roll is then in particular also mounted at one end in a “cantilevered” manner on the machine frame.

On the cutting roll for example one or more transverse cutting edges are disposed. For example, the rotary cutting device is configured as a transverse cutting device. It is therefore possible for example to cut material webs at a high cutting rate.

It is also additionally or alternatively possible for one or more longitudinal cutting edges to be disposed on the cutting roll. In particular, cutting edges are configured in a way that allows the introduction of profile cuts.

The following description of preferred embodiments serves in connection with the drawings to provide a detailed explanation of the invention.

### BRIEF DESCRIPTION OF THE DRAWINGS

FIG. 1 shows a side view of an embodiment of a rotary cutting device according to the invention;

FIG. 2 shows a diagrammatic representation of a counter roll;

FIG. 3 shows a frontal plan view of the counter roll according to FIG. 2;

FIG. 4 shows a sectional view of the counter roll along the line 4-4 according to FIG. 3;

FIG. 5 shows an enlarged representation of the area A according to FIG. 4;

FIG. 6 shows diagrammatically the deformation of an inner core of the counter roll over the length thereof under the action of a cutting force;

FIG. 7 shows adapted thereto, the deformation of a corresponding rotary roll when the latter acts upon the counter roll;

FIG. 8 shows diagrammatically the deformation of an outer sleeve compared to the inner core in the solution according to the invention;

FIG. 9 shows a second embodiment of a rotary cutting device (transverse cutting device) according to the invention;

FIG. 10 shows a sectional view of the rotary cutting device according to FIG. 9; and

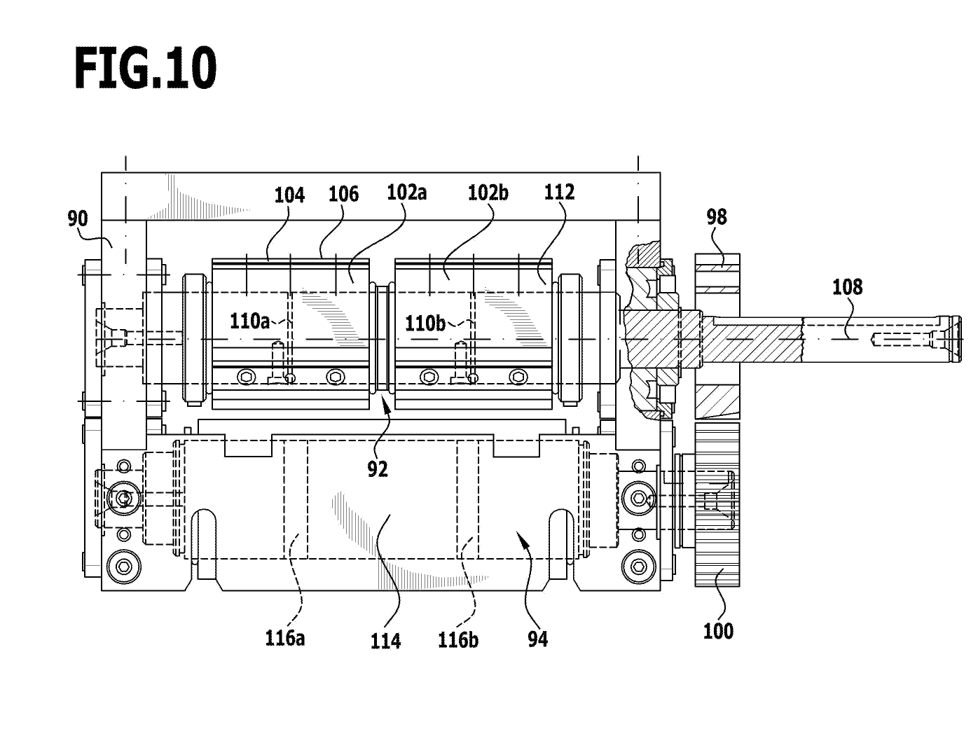

FIG. 11 shows a third embodiment of a rotary cutting device according to the invention.

### DETAILED DESCRIPTION

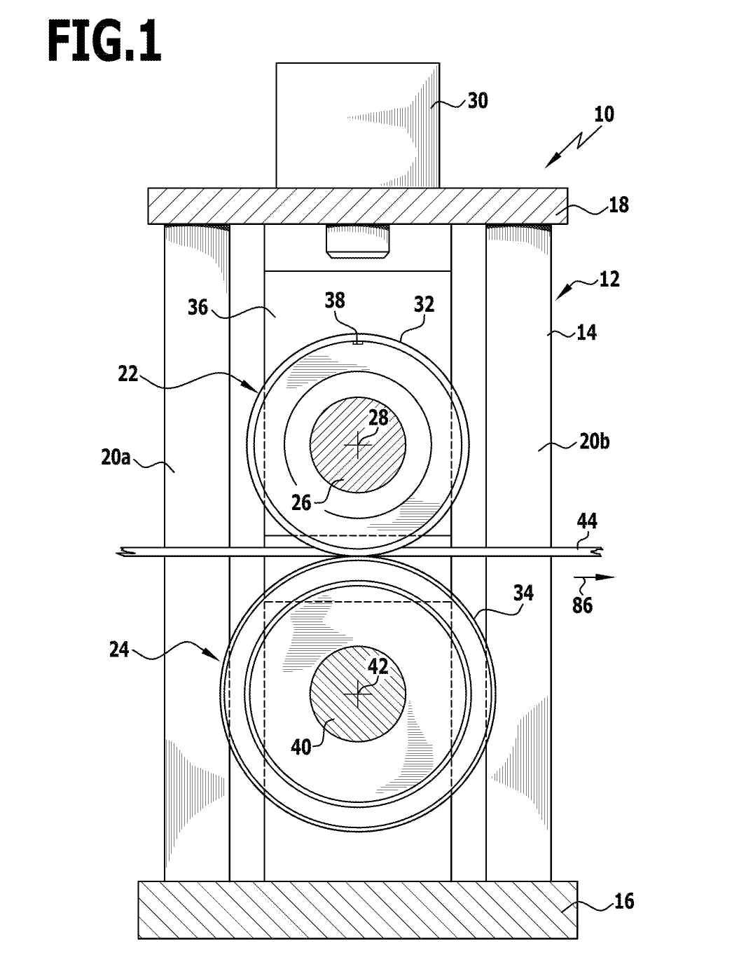

A first embodiment of a rotary cutting device according to the invention, which is shown in FIG. 1 and denoted there by 10, is realized as a rotary cutting machine. It comprises a machine frame 12, which is of a column-like design. The machine frame 12 comprises opposing columns 14, which are connected by a bottom bridge 16 and a top bridge 18. The rotary cutting device 10 is positioned via the bottom bridge 16 on a foundation.

The respective columns 14 in turn comprise opposing column supports 20a, 20b.

On the columns 14 of the machine frame 12 in each case a cutting roll 22 and a counter roll 24 (anvil roll) are rotatably mounted. The cutting roll 22 in this case is mounted by means of opposite-lying pivot bearings 26 so as to be rotatable about an axis 28. In FIG. 1 the axis 28 is perpendicular to the drawing plane.

Associated with the cutting roll 22 is a drive for the rotational movement (not shown in the drawings). By means of a bias device 30 the cutting roll 22 may be pressed against the counter roll 24.

The cutting roll 22 is supported by opposite-lying supporting rings 32 on a surface 34 of the counter roll 24. Alternatively, it is also possible for the counter roll 24 to be provided with supporting rings that are supported on a surface of the cutting roll 22.

The pivot bearings 26 for the cutting roll 22 are disposed on a respective bearing device 36, which is displaceable linearly on the machine frame 12. By means of the bias device 30 the bearing device 36 as a whole (including the pivot bearings 26 and the cutting roll 22) may be displaced towards the counter roll 24 in order to exert a cutting force.

The cutting roll 22 comprises one or more cutting edges 38, which are disposed between the supporting rings 32.

The counter roll 24 is likewise mounted rotatably about an axis 42 by means of opposite-lying pivot bearings 40, which are disposed on the respective columns 14. The axis 42 is parallel to the axis 28.

To carry out a cutting operation, a material 44 to be cut, which is in particular in the form of a web, is passed through between the counter roll 24 and the cutting roll 22 between the supporting rings 32. The counter roll 24 and the cutting roll 22 rotate in opposite directions to one another. By means of the bias device 30 the cutting roll 22 is pressed against the counter roll 24 in order to exert a cutting force.

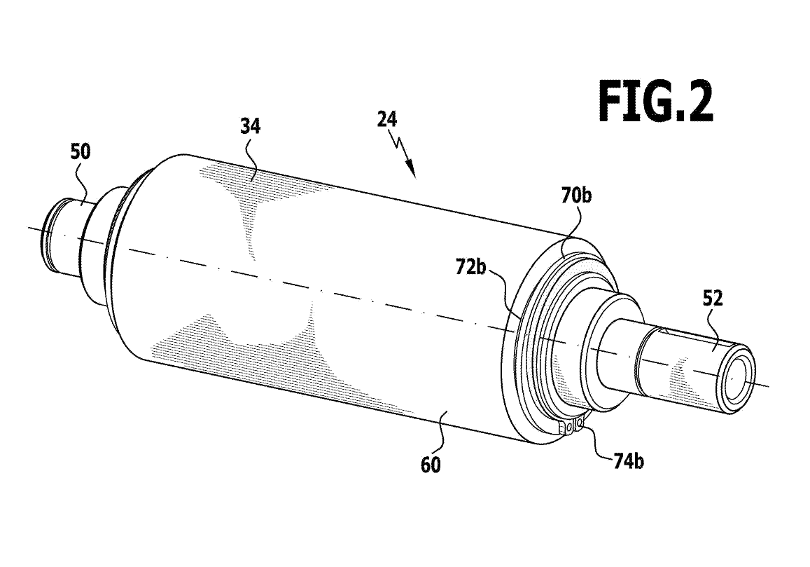

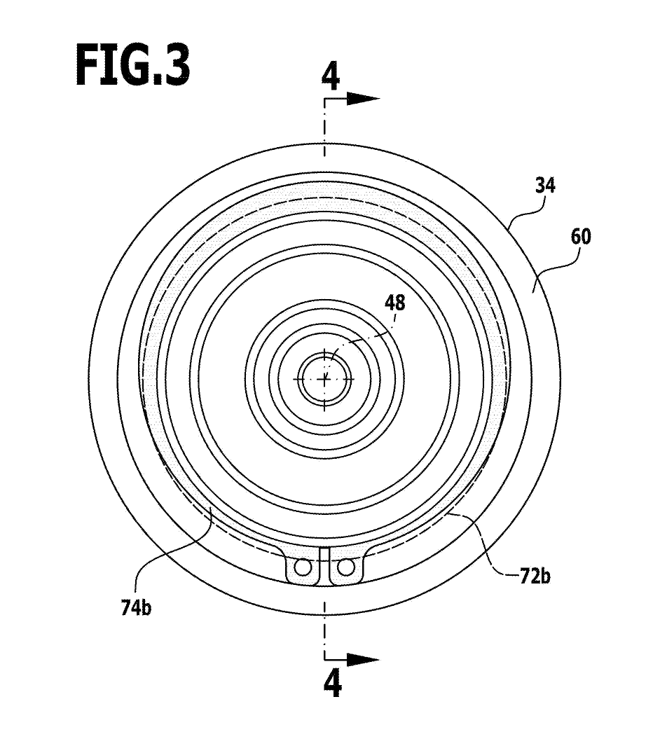

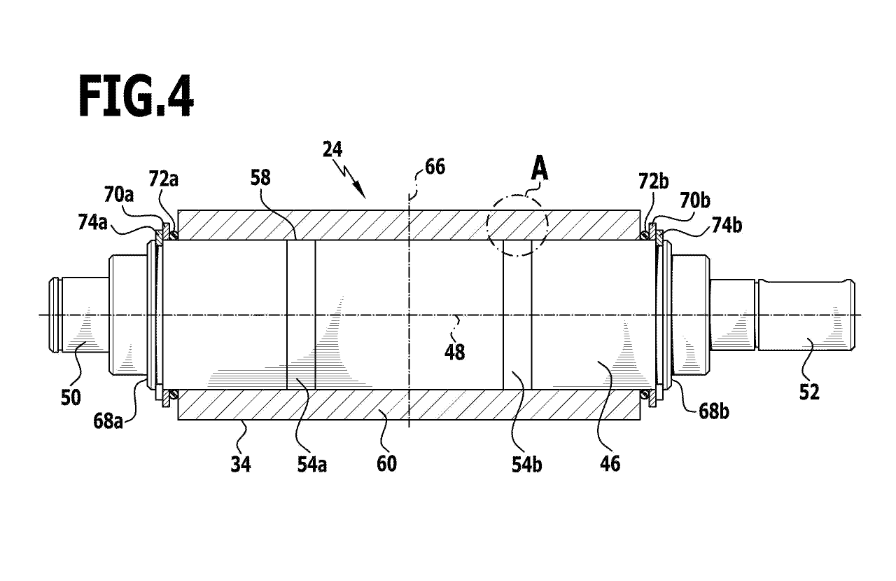

The counter roll 24 comprises an inner core 46 (FIGS. 2 to 4). The inner core 46 is in particular of a cylindrical design and rotationally symmetrical relative to an axis 48, which coincides with the axis of rotation 42.

Disposed on the inner core are a first shaft stub 50 and a second shaft stub 52, by means of which the counter roll 24 is rotatably mounted.

In the illustrated embodiment, a first counter bearing 54a and a second counter bearing 54b are disposed on the inner core 46. These counter bearings 54a, 54b are of an annular design and disposed in the manner of a band on the inner core 46. The counter bearings 54a, 54b in this case may be integrally connected to the inner core 46 or may be separate parts that are fixed on the inner core 46.

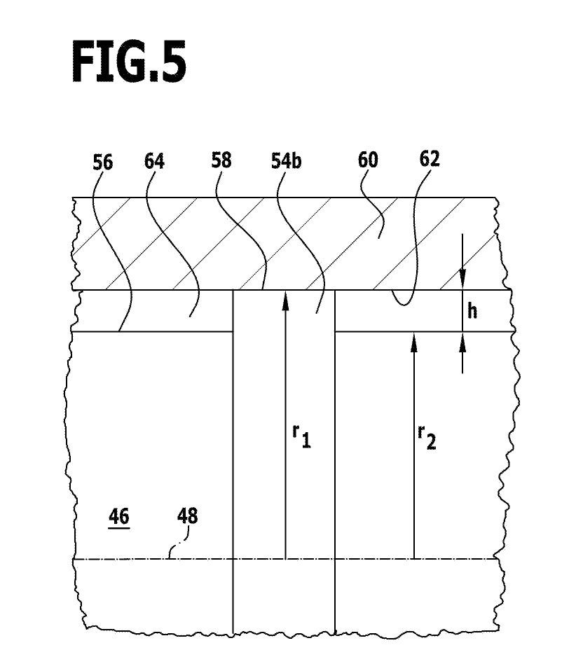

The first counter bearing 54a and the second counter bearing 54b, as indicated in FIG. 5, have a larger radius r1 than a surface region 56 (radius r2) of the inner core 46 outside of the counter bearings 54a, 54b. The counter bearings 54a, 54b therefore project in a step-like manner from the surface region 56.

They comprise in each case a contact region 58 that is spaced radially apart from the surface region 56 of the inner core 46.

The counter bearings 54a, 54b are “discrete” supports having a width (parallel to the axis 48) that is considerably smaller than the total length of the counter roll 24. In particular, this width is smaller than 30% of the total length. In principle, the smaller the width of a counter bearing 54a, 54b, the more advantageous it is for the introduction of force. The smaller the width, the less the mobility of the outer sleeve 60 relative to the inner core 46 is impeded. It is however necessary in this case to ensure that the pressure per unit area acting upon a counter bearing still lies within the elastic range of the counter bearing in order to prevent any plastic deformation. For example, the relative width of a counter bearing in relation to the total length of a cutting roll or counter roll may lie also in a range of 0.5% or less. The extent is dependent upon the particular condition of the corresponding rotary cutting device.

The counter roll 24 further comprises an outer sleeve 60, on which the surface 34 of the counter roll 24 is formed. This surface 34 is in particular cylindrical. The outer sleeve 60 has the shape of a hollow cylinder. The cutting roll 22 with the supporting rings 32 acts upon this outer sleeve 60.

The outer sleeve 60 is supported on the discrete counter bearings 54a, 54b non-rotatably with regard to the inner core 46; the outer sleeve 60 is mounted on the inner core 46, not by the entire surface region 56, but only by the contact regions 58 of the counter bearings 54a, 54b. Between an inner side 62 of the outer sleeve 60 and the surface region 56 of the inner core 46 an intermediate space 64 is formed. This intermediate space 64 allows a relative excursion between the outer sleeve 60 and the inner core 46 in particular by means of differing elastic deformation of the inner core 46 and the outer sleeve 60.

The first counter bearing 54a and the second counter bearing 54b are disposed symmetrically on the inner core 46. They are equidistant from a centre plane 66 of the counter roll 24. The centre plane 66 in this case lies at right angles to the axis 48. The first counter bearing 54a is moreover at the same distance from a first end face 68a of the inner core 46 (outside of the first shaft stub 50) as the second counter bearing 54b is from an opposite-lying second end face 68b.

The outer sleeve 60 is fixed in relation to the inner core 46. For example, it is fixed by positive-locking means by means of the counter bearings 54a, 54b on the inner core 46.

It may additionally or alternatively be provided that the outer sleeve 60 is restrained axially. For this purpose there are provided for example opposite-lying support rings 70a, 70b, which are disposed in the vicinity of the first end face 68a and second front face 68b respectively. Disposed between each support ring 70a, 70b and a respective end face of the outer sleeve 60 is a seal 72a, 72b, wherein this seal in particular has the shape of an O-ring. By means of the seals 72a, 72b the intermediate space 64 is sealed off at each end face of the outer sleeve 60.

The support rings 70a, 70b are held on the inner core 46 by means of respective locking rings 74a, 74b in a direction away from the outer sleeve 60.

A height h of the intermediate space 64 lies for example in the range of between 2 μm and 100 μm depending on the individual application. The height h may also be smaller or larger than has just been mentioned.

The counter roll 24 is provided with at least one counter bearing in the manner described. It may alternatively or additionally be provided that the cutting roll 22 is provided with one or more counter bearings. The construction and arrangement of such counter bearings on the cutting roll 22 is in principle the same as described in connection with the counter roll 24.

During a rotary cutting operation the cutting roll 22 is pressed by the bias device 30 against the counter roll. By virtue of the cutting forces a force is exerted on the counter roll 24 and an opposing force is exerted on the cutting roll 22.

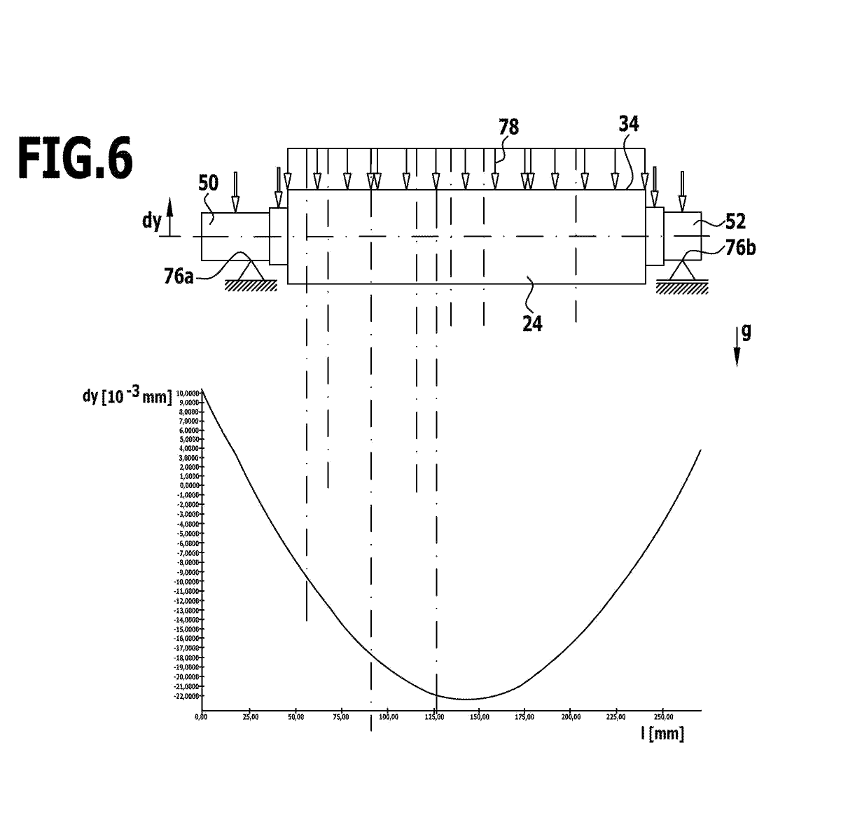

The counter roll 24 is restrained by its pivot bearings 40 in the region of the first shaft stub 50 and the second shaft stub 52 in each case on the machine frame 12. This is indicated in FIG. 6 by the supporting points 76a, 76b. By means of the cutting roll 22 forces 78 are exerted from the direction of the cutting roll. In the illustrated embodiment, these forces 78 act from above in relation to the gravitational force direction g. These forces 78 give rise to a bowing of the counter roll 24 (above all, of the inner core 46) in a downward direction.

In FIG. 6 a graph for a counter roll having a diameter of 50 mm is shown, in which the excursion dy of the inner core 46 over the length l of the counter roll 24 is shown. In this case, cutting forces in the order of magnitude of 125 N/mm were exerted.

It is evident that in a central region of the counter roll 24 the inner core 46 experiences a downward excursion in the order of magnitude of 22 μm.

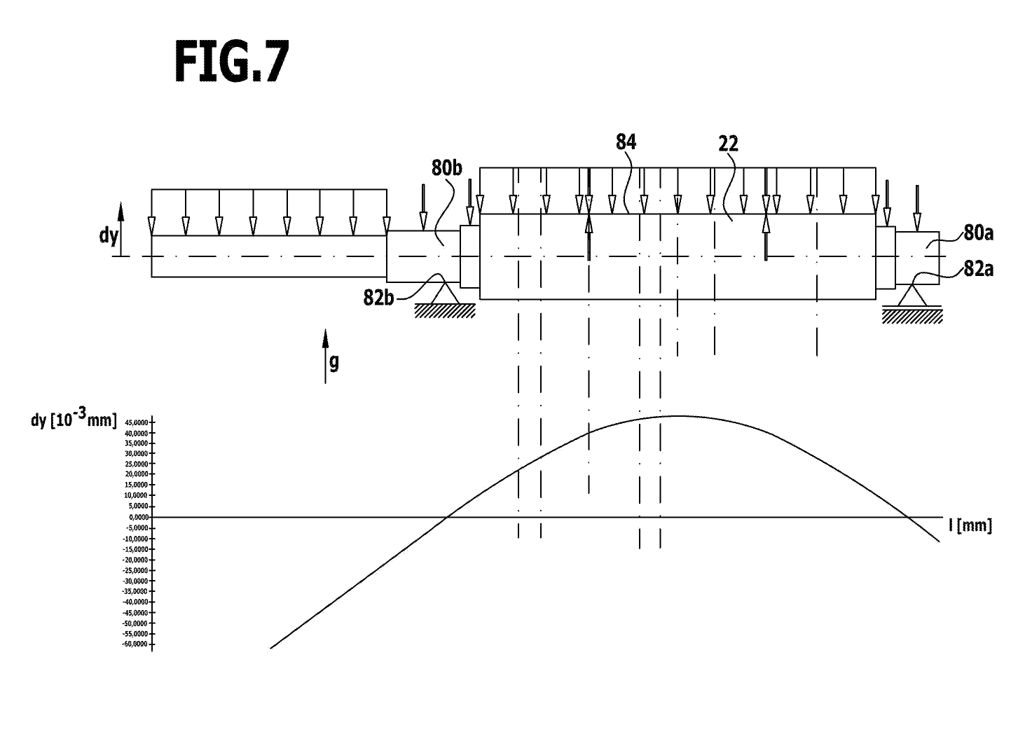

In FIG. 7 the cutting roll 22 is shown with a shaft stub 80a and a shaft stub 80b. By means of the bias device 30 a force is exerted in the direction of the counter roll 24. In the illustrated embodiment, this is a force parallel to the gravitational force direction g. The cutting roll 22 in this case is clamped in place in an upward direction. This is indicated in FIG. 7 by supporting points 82a, 82b.

Because of the effective forces and in particular the reaction force of the counter roll 24, the cutting roll 22 is bent in an upward direction. In particular, an inner core of the cutting roll 22, if the cutting roll has such an inner core, is bent in an upward direction.

In FIG. 7 a graph of the excursion of the cutting roll and/or of an inner core of the cutting roll over the length l of the cutting roll 22 is shown. The data correspond to a cutting roll having a diameter of 40 mm with effective cutting forces of 125 N/mm.

It is evident that in the central region of the cutting roll 22 there is an upward excursion of ca. 40 μm.

If FIGS. 6 and 7 are compared, then with regard to the corresponding inner cores of the cutting roll 22 and the counter roll 24 there would be in the central region a relative excursion of opposite-lying surface regions of the cutting roll 22 and the counter roll 24 of ca. 60 μm, if these surface regions were to follow the bowing of the inner cores. Such excursions, if present at the surface of the counter roll 24 and the cutting roll 22, impair the quality of the cutting result.

These disturbing excursions at the surfaces are in particular all the greater, the longer the cutting roll 22 and the counter roll 24 are and the smaller the diameter of these rolls is.

In the solution according to the invention, the outer sleeve 60 is supported by means of the counter bearings 54a, 54b on the inner core 46. (This support may be provided both for the cutting roll 22 and for the counter roll 24 or only for the cutting roll 22 or only for the counter roll 24.) This allows forces during the cutting operation and in particular cutting forces to be introduced and removed in a defined manner. Via the counter bearings 54a, 54b cutting forces may be introduced from the outer sleeve 60 into the inner core 46 and therefore removed via the corresponding pivot bearings 26 and/or 40.

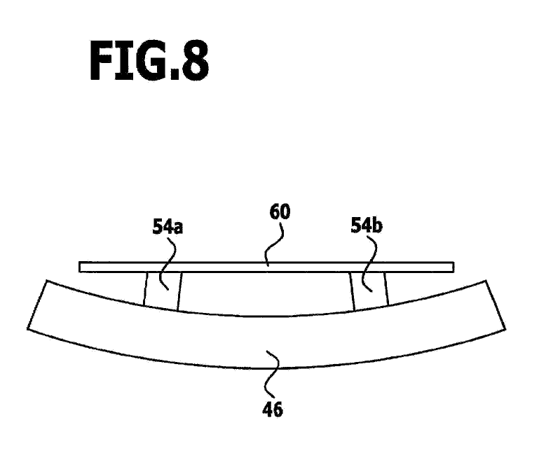

Given a corresponding arrangement of the at least one counter bearing, the effect may be achieved that the outer sleeve 60 is bent to a lesser extent than the corresponding inner core 46. This is indicated in a highly exaggerated manner in FIG. 8. As a result of the cutting forces the inner core 46 experiences an elastic deformation and in particular bowing. The outer sleeve 60 also experiences in principle an elastic deformation and bowing. By virtue of the supporting of the outer sleeve 60 on the counter bearings 54a, 54b with the defined introduction of force, it is possible to keep the deformation of the outer sleeve 60 considerably lower than that of the inner core 46. This means that during the build-up of cutting forces a relative excursion and/or relative movement between the outer sleeve 60 and the inner core 46 is obtained. If the outer sleeve 60 is bent to a lesser extent than the inner core 46, then, in relation to the starting point with no effective cutting forces, the surface 34 of the outer sleeve 60 (when it is a case of the outer sleeve of the counter roll 24) is bent to a lesser extent than the inner core 46. This means that the deviation of the surface 34 of the outer sleeve 60 from the “ideal line” is less pronounced than if no discrete counter bearings 54a, 54b are provided. This in turn means that the relative excursion of the surface 34 relative to the cutting roll 22 is less pronounced and better cutting results are obtained. In particular, this also allows the use of longer counter rolls 24 of a smaller diameter.

The described advantages also exist when the cutting roll 22 is mounted by an outer sleeve by means of discrete counter bearings on the corresponding inner core. If the cutting roll 22 is also provided with the solution according to the invention, the result is an, as a whole, smaller relative excursion of the surfaces of the cutting roll 22 and the counter roll 24.

Depending on the individual application and in particular the configuration of the cutting roll 22, one or more counter bearings are provided. These counter bearings are disposed and configured in such a way that a symmetrical flow of force arises at the cutting roll 22 and/or the counter roll 24. The flow of force is in this case in particular symmetrical relative to the centre plane 66.

By virtue of the solution according to the invention a defined removal of the flow of force is obtained at the counter roll 24 and/or the cutting roll 22. This allows the outer sleeve 60 to deform elastically to a lesser extent than the corresponding inner core 46. This in turn means that surface regions 84 of the cutting roll 22 (if this is provided with one or more counter bearings) and/or of the counter roll 24 (if this is provided with one or more counter bearings) are deformed to a lesser extent than if the outer sleeve 60 was seated by its “full surface” on the inner core 46 and/or no outer sleeve at all was provided.

The rotary cutting device 10 is for example configured in such a way that on the cutting roll 22 cutting edges are disposed, which are arranged in a longitudinal direction (in relation to a longitudinal direction 86 (FIG. 1) for the conveying of material 44) and in a transverse direction thereto.

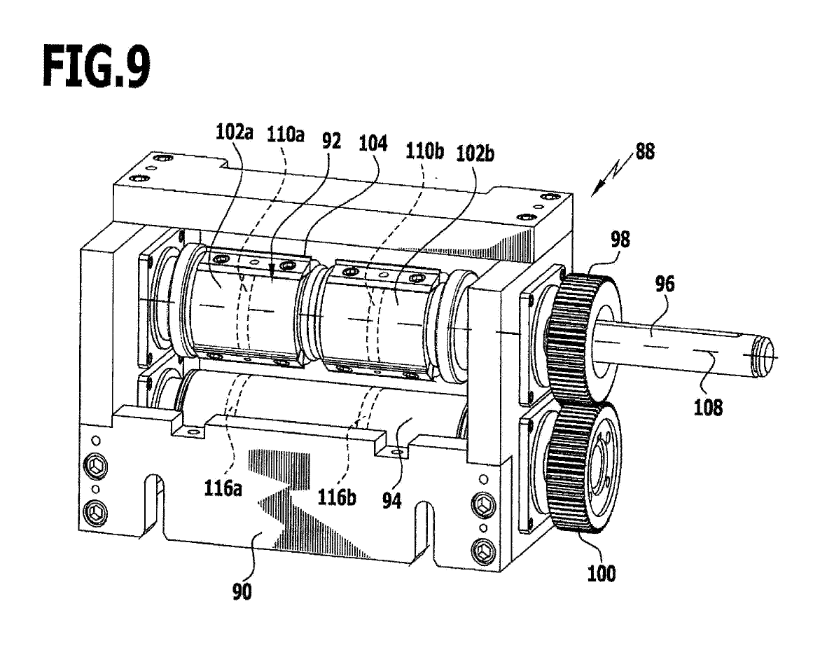

A second embodiment of a rotary cutting device according to the invention, which is shown in FIG. 9 and denoted there by 88, comprises a machine frame 90, on which in basically the same manner as described above a cutting roll 92 and a counter roll 94 are in each case rotatably mounted. The counter roll 94 is of basically the same design as the counter roll 24 as described above.

The cutting roll 92 is for example driven by a drive (not shown in the drawing). Disposed on a shaft stub 96 of the cutting roll is a gear wheel 98, which meshes into a gear wheel 100 that is fastened in a rotationally fixed manner relative to the counter roll 94. Thus, by driving the cutting roll 92 the counter roll 94 can also be driven.

The cutting roll 92 comprises a first roll region 102a and a second roll region 102b, wherein these two roll regions 102a, 102b are spaced apart from one another. On the first roll region 102a and the second roll region 102b in each case a plurality of transverse cutting edges 104 are disposed. These transverse cutting edges 104 are disposed in a uniformly distributed manner.

For example, they are spaced apart by an angle of 120° (relative to a cross section).

The transverse cutting edges 104 comprise a cutting surface 106, which are transverse and in particular at right angles to a direction of conveying of material through the rotary cutting device 88. In particular, the cutting surfaces 106 are oriented parallel to an axis of rotation 108 of the cutting roll 92.

Counter bearings 110a, 110b are disposed in a central region of the first roll region 102a and the second roll region 102b respectively. The counter bearing 110a, 110b in this case is of basically the same design as described above. In particular, these are annular regions that are disposed on a respective inner core 112 of the cutting roll 92.

The counter roll 94 likewise comprises an inner core 114, on which spaced-apart counter bearings 116a, 116b are disposed. In particular, the counter bearings 116a, 116b are aligned with the counter bearings 110a, 110b and positioned directly opposite so that a direct introduction of force at the counter bearings is possible. The counter bearing 116a is then positioned opposite the counter bearing 110a, and the counter bearing 116b is positioned opposite the counter bearing 110b.

Otherwise, the rotary cutting device 88 operates in the manner described above.

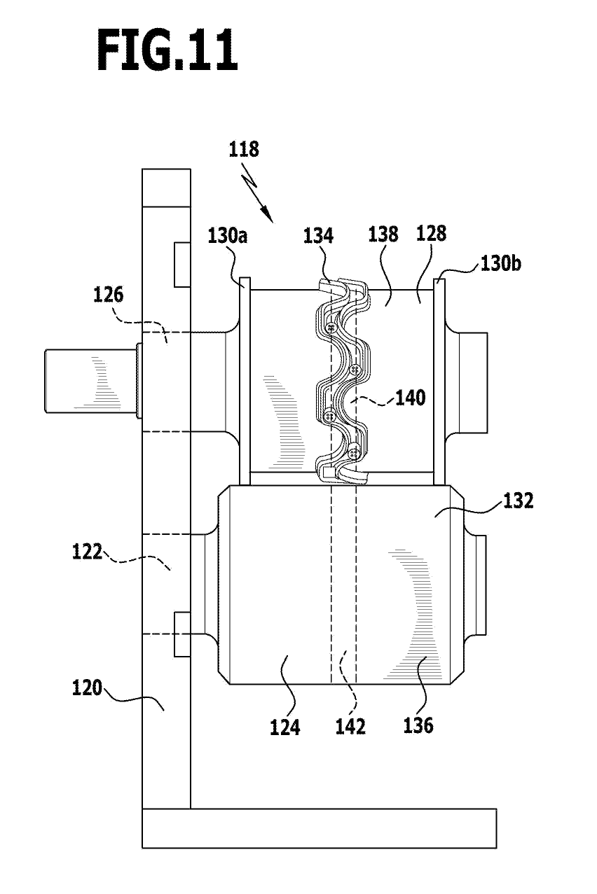

In a third embodiment of a rotary cutting device, which is shown in FIG. 11 and denoted there by 118, a machine frame 120 is provided. On the machine frame 120 a first pivot bearing 122 for a counter roll 124 is disposed. A second pivot bearing 126 is further disposed on the machine frame 120 at a distance from, for example above, the first pivot bearing 122. By means of this second pivot bearing 126 a cutting roll 128 is rotatably mounted. The cutting roll 128 and the counter roll 124 are therefore in each case not mounted at two ends on the machine frame 120 but held only at one end in a “cantilevered” manner on the machine frame 120.

The cutting roll 128 comprises for example oppositely-lying supporting rings 130a, 130b. By means of these supporting rings 130a, 130b the cutting roll 128 is supported on a surface 132 of the counter roll 124. A construction with no supporting ring is also possible.

The cutting roll 128 is provided with cutting edges 134. The cutting edges 134 are of a design adapted to the material to be cut.

The counter roll 124 and the cutting roll 128 comprise in each case, as described above, an inner core and respective outer sleeves 136 and 138. The outer sleeve 138 of the cutting roll 128 in this case is supported by a single counter bearing 140 on the corresponding inner core of the cutting roll 128.

The outer sleeve 136 of the counter roll 124 is supported by a counter bearing 142 on the inner core of the counter roll 124. The counter bearings 140 and 142 lie directly opposite in order to enable a direct introduction of force.

Otherwise, the rotary cutting device 118 operates in the manner described above.

What is claimed is:

1. A rotary cutting device, comprising:
a machine frame;
a cutting roll rotatably mounted on the machine frame; and
a counter roll rotatably mounted on the machine frame;
wherein:
the cutting roll is supported on the counter roll by means of at least one supporting ring;
at least one of the cutting roll and the counter roll comprise an inner core and an outer sleeve disposed around the inner core;
the outer sleeve is spaced apart from the inner core by an intermediate space;
a plurality of counter bearings are disposed on the inner core on which the outer sleeve is supported;
the outer sleeve is supported non-rotatably on the counter bearings with regard to the inner core;
the intermediate space is provided between adjacent ones of the counter bearings;
the counter bearings allow forces exerted by the cutting roll and counter roll on one another to be guided away in a defined manner by use of the counter bearings on the corresponding at least one of the counter roll and cutting roll;
during a cutting operation a bowing of the outer sleeve is smaller than a bowing of the inner core; and
the width of the counter bearings is smaller than 30% of the total length of the corresponding at least one of the counter roll and the cutting roll.

2. A rotary cutting device according to claim 1, wherein the counter bearings are disposed and configured in such a way that the outer sleeve is movable by elastic deformation relative to the inner core.

3. A rotary cutting device according to claim 1, wherein during the cutting operation the corresponding counter bearings provide, for at least one of the cutting roll and the counter roll, an at least approximately symmetrical distribution of the flow of force in relation to at least one of the cutting roll length and counter roll length.

4. A rotary cutting device according to claim 1, wherein the counter bearings comprise an annular region that is disposed on the inner core.

5. A rotary cutting device according to claim 4, wherein a width of the annular region is smaller than 30% of the total length of the corresponding at least one of the counter roll and the cutting roll.

6. A rotary cutting device according to claim 1, wherein the outer sleeve is fixed on the counter bearings.

7. Rotary cutting device according to claim 1, wherein at least one seal is disposed between the outer sleeve and the inner core.

8. Rotary cutting device according to claim 7, wherein the at least one seal is disposed on an end face of the outer sleeve.

9. A rotary cutting device according to claim 1, wherein the counter bearings are disposed symmetrically on the corresponding at least one of the cutting roll and counter roll.

10. Rotary cutting device according to claim 1, wherein one or more cutting edges are disposed on the outer sleeve of the cutting roll.

11. A rotary cutting device according to claim 1, wherein:
the cutting roll and the counter roll are each provided with the counter bearings, and
the counter bearings lie opposite one another.

12. Rotary cutting device according to claim 1, wherein a first supporting ring and a second supporting ring are provided, wherein the counter bearings are disposed on at least one of the counter roll and cutting roll between the first supporting ring and the second supporting ring.

13. Rotary cutting device according to claim 1, wherein the counter roll is rotatably mounted.

14. Rotary cutting device according to claim 1, wherein the cutting roll is mounted at two ends on the machine frame.

15. Rotary cutting device according to claim 14, wherein the counter roll is mounted at two ends on the machine frame.

16. Rotary cutting device according to claim 1, wherein the cutting roll is mounted at one end on the machine frame.

17. Rotary cutting device according to claim 16, wherein the counter roll is mounted at one end on the machine frame.

18. Rotary cutting device according to claim 1, wherein one or more transverse cutting edges are disposed on the cutting roll.

19. Rotary cutting device according to claim 1, wherein one or more longitudinal cutting edges are disposed on the cutting roll.

20. Rotary cutting device according to claim 1, wherein the inner core and the outer sleeve form a unit that is rotatably held on the machine frame, with the inner core and the outer sleeve being non-rotatable with regard to each other.
